(19) United States
(12) Patent Application Publication
(10) Pub. No.: US 2026/0331836 A1
(43) Pub. Date: Oct. 22, 2026

(54) Electrical Connector

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/651,508

(22) Filed: Apr. 17, 2026

(30) Foreign Application Priority Data
Apr. 18, 2025 (TW) 114114878

(51) Int. Cl. H01R 13/6585; H01R 13/6599; H01R 24/60

(52) U.S. Cl. CPC H01R 13/6585; H01R 13/6599; H01R 24/60

(57) ABSTRACT

An electrical connector comprises a plurality of non-grounded conductive terminal sets and a shielding conductive member, wherein the shielding conductive member is disposed between the plurality of non-grounded conductive terminal sets, and the shielding conductive member transmits a shielding signal such as a grounded signal to provide electrical shielding for signal transmission through the plurality of non-grounded conductive terminal sets. Thus, interference during high-speed signal transmission of the electrical connector can be effectively reduced, thereby optimizing the transmission quality of high-speed signals for the electrical connector to meet specific requirements and development of electronic devices.

### CROSS-REFERENCE TO RELATED APPLICATIONS

This application claims the priority of Republic of China Patent Application No. 114114878 filed on Apr. 18, 2025, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to an electrical connector capable of reducing interference during high-speed signal transmission.

### Descriptions of the Related Art

In recent years, electrical connectors have been widely used in various electronic devices that can thus transmit signals through a plurality of conductive terminals on the electrical connectors. The plurality of conductive terminals of the electrical connector may be required for transmitting high-speed signals in response to the specific requirements and development of the electronic devices. However, the current electrical connectors are susceptible to interference when transmitting high-speed signals (the interference is, for example, electromagnetic interference from the external environment, or crosstalk interference caused by coupling between the plurality of conductive terminals of the electrical connector), which causes the high-speed signals transmitted by the electrical connector to be prone to quality degradation.

From the above, how to solve the problem that electrical connectors are susceptible to interference during high-speed signal transmission is indeed an urgent problem to be solved by those skilled in the art.

### SUMMARY OF THE INVENTION

In view of the drawbacks of the prior art mentioned above, the present application provides an electrical connector, two sides of the electrical connector being an electrical connector major side and an electrical connector minor side, the electrical connector comprising: an electrical connector body comprising a coupling space, a major side non-grounded conductive terminal separating space, and a minor side non-grounded conductive terminal separating space; a major side electrical connector submodule disposed at the electrical connector major side, the major side electrical connector submodule comprising a major side non-grounded conductive terminal set and a major side coupling space shielding conductive member, the major side non-grounded conductive terminal set comprising a first major side non-grounded conductive terminal and a second major side non-grounded conductive terminal, wherein the major side non-grounded conductive terminal separating space is disposed between the first major side non-grounded conductive terminal and the second major side non-grounded conductive terminal to separate the first major side non-grounded conductive terminal from the second major side non-grounded conductive terminal; the first major side non-grounded conductive terminal and the second major side non-grounded conductive terminal extend into the coupling space to provide coupling; and the major side coupling space shielding conductive member extends into the coupling space to provide electrical shielding for the first major side non-grounded conductive terminal and the second major side non-grounded conductive terminal; a minor side electrical connector submodule disposed at the electrical connector minor side, the minor side electrical connector submodule comprising a minor side non-grounded conductive terminal set and a minor side coupling space shielding conductive member, the minor side non-grounded conductive terminal set comprising a first minor side non-grounded conductive terminal and a second minor side non-grounded conductive terminal, wherein the minor side non-grounded conductive terminal separating space is disposed between the first minor side non-grounded conductive terminal and the second minor side non-grounded conductive terminal to separate the first minor side non-grounded conductive terminal from the second minor side non-grounded conductive terminal; the first minor side non-grounded conductive terminal and the second minor side non-grounded conductive terminal extend into the coupling space to provide coupling; and the minor side coupling space shielding conductive member extends into the coupling space to provide electrical shielding for the first minor side non-grounded conductive terminal and the second minor side non-grounded conductive terminal; a grounded conductive terminal extending from the electrical connector major side into the major side non-grounded conductive terminal separating space to provide electrical shielding between the first major side non-grounded conductive terminal and the second major side non-grounded conductive terminal; the grounded conductive terminal further extending from the electrical connector minor side into the minor side non-grounded conductive terminal separating space to provide electrical shielding between the first minor side non-grounded conductive terminal and the second minor side non-grounded conductive terminal; and the grounded conductive terminal further extending from the electrical connector major side and the electrical connector minor side into the coupling space to provide coupling; a bridging conductive member extending into the coupling space to electrically abut the major side coupling space shielding conductive member and the minor side coupling space shielding conductive member respectively, such that the major side coupling space shielding conductive member and the minor side coupling space shielding conductive member are electrically connected to each other; and a mating conductive member extending to and respectively mated with the grounded conductive terminal and the bridging conductive member, so as to position the bridging conductive member by the grounded conductive terminal and to electrically connect the grounded conductive terminal and the bridging conductive member.

Preferably, the electrical connector said above, wherein the major side coupling space shielding conductive member, the minor side coupling space shielding conductive member, the bridging conductive member, and the mating conductive member are conductive metal members.

Preferably, the electrical connector said above, wherein the bridging conductive member extends substantially laterally, and the mating conductive member extends substantially longitudinally.

Preferably, the electrical connector said above, wherein the major side electrical connector submodule further comprises a major side terminal insulation core mated with the major side non-grounded conductive terminal set and the major side coupling space shielding conductive member to position the first major side non-grounded conductive terminal, a second major side non-grounded conductive terminal, and the major side coupling space shielding conductive member; and the minor side electrical connector submodule further comprises a minor side terminal insulation core mated with the minor side non-grounded conductive terminal set and the minor side coupling space shielding conductive member to position the first minor side non-grounded conductive terminal, a second minor side non-grounded conductive terminal, and the minor side coupling space shielding conductive member.

Preferably, the electrical connector said above, wherein the major side coupling space shielding conductive member comprises a major side coupling space shielding conductive member shielding wall and a major side coupling space shielding conductive member mating wall, wherein the major side coupling space shielding conductive member shielding wall is disposed in the coupling space to provide electrical shielding for the first major side non-grounded conductive terminal and the second major side non-grounded conductive terminal; and the major side terminal insulation core is mated with the major side coupling space shielding conductive member mating wall to position the major side coupling space shielding conductive member; and the minor side coupling space shielding conductive member comprises a minor side coupling space shielding conductive member shielding wall and a minor side coupling space shielding conductive member mating wall, wherein the minor side coupling space shielding conductive member shielding wall is disposed in the coupling space to provide electrical shielding for the first minor side non-grounded conductive terminal and the second minor side non-grounded conductive terminal; and the minor side terminal insulation core is mated with the minor side coupling space shielding conductive member mating wall to position the minor side coupling space shielding conductive member.

Preferably, the electrical connector said above, wherein the major side coupling space shielding conductive member shielding wall and the major side coupling space shielding conductive member mating wall are substantially perpendicular to each other; and the minor side coupling space shielding conductive member shielding wall and the minor side coupling space shielding conductive member mating wall are substantially perpendicular to each other.

Preferably, the electrical connector said above, wherein the electrical connector body further comprises an engaging space; the first major side non-grounded conductive terminal and the second major side non-grounded conductive terminal further extend into the engaging space to provide engagement; the first minor side non-grounded conductive terminal and the second minor side non-grounded conductive terminal further extend into the engaging space to provide engagement; the grounded conductive terminal further extends from the electrical connector major side and the electrical connector minor side respectively into the engaging space to provide engagement; and the electrical connector further comprises an engaging space shielding conductive member extending into the engaging space to provide electrical shielding between the major side non-grounded conductive terminal set and the minor side non-grounded conductive terminal set; the grounded conductive terminal further comprises an engaging space shielding conductive member mating structure mated with the engaging space shielding conductive member to position the engaging space shielding conductive member and to electrically connect the grounded conductive terminal and the engaging space shielding conductive member.

Preferably, the electrical connector said above, wherein the engaging space shielding conductive member comprises a major side engaging space shielding conductive sub-member and a minor side engaging space shielding conductive sub-member; wherein the major side engaging space shielding conductive sub-member is disposed at the electrical connector major side, and the minor side engaging space shielding conductive sub-member is disposed at the electrical connector minor side.

Preferably, the electrical connector said above, wherein the engaging space shielding conductive member is a conductive plastic member.

Preferably, the electrical connector said above, further comprising: an insulation housings mated with the major side terminal insulation core, the minor side terminal insulation core, and the grounded conductive terminal to position the major side terminal insulation core, the minor side terminal insulation core, and the grounded conductive terminal.

Compared to the prior art, the electrical connector provided by the present application can be disposed in an electronic device for signal transmission, and the electrical connector comprises a plurality of non-grounded conductive terminal sets, a shielding conductive member and a grounded conductive terminal. Wherein, the shielding conductive member is disposed between the plurality of non-grounded conductive terminal sets, the grounded conductive terminal is capable of being electrically connected to the shielding conductive member to transmit a shielding signal such as a grounded signal to provide electrical shielding for signal transmission of the plurality of non-grounded conductive terminal sets. Thus, interference during high-speed signal transmission of the electrical connector can be effectively reduced, thereby optimizing the transmission quality of the electrical connector for high-speed signals to meet specific requirements and development of electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of the electrical connector of the present application in one embodiment.

FIG. 2 is a perspective schematic view from a first perspective of the electrical connector of the present application in one embodiment.

FIG. 3 is a perspective schematic view from a second perspective of the electrical connector of the present application in one embodiment.

FIG. 4 is a front schematic view of the electrical connector of the present application in one embodiment.

FIG. 5 is a cross-sectional schematic view of some members of the electrical connector shown in FIG. 4 taken along line AA.

FIG. 6 is a cross-sectional schematic view of some members of the electrical connector shown in FIG. 4 taken along line BB.

FIG. 7 is a cross-sectional schematic view of some members of the electrical connector shown in FIG. 4 taken along line CC.

FIG. 8 is a perspective schematic view of the electrical connector of the present application in one embodiment.

FIG. 9 is a perspective schematic view of the electrical connector of the present application in one embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The present application provides an electrical connector. The electrical connector is disposed with a plurality of non-grounded conductive terminal sets and a shielding conductive member, wherein the shielding conductive member is disposed between the plurality of non-grounded conductive terminal sets, and the shielding conductive member transmits a shielding signal such as a grounded signal to provide electrical shielding for signal transmission of the plurality of non-grounded conductive terminal sets. Thus, interference during high-speed signal transmission of the electrical connector can be effectively reduced, thereby optimizing the transmission quality of the electrical connector for high-speed signals to meet specific requirements and development of electronic devices.

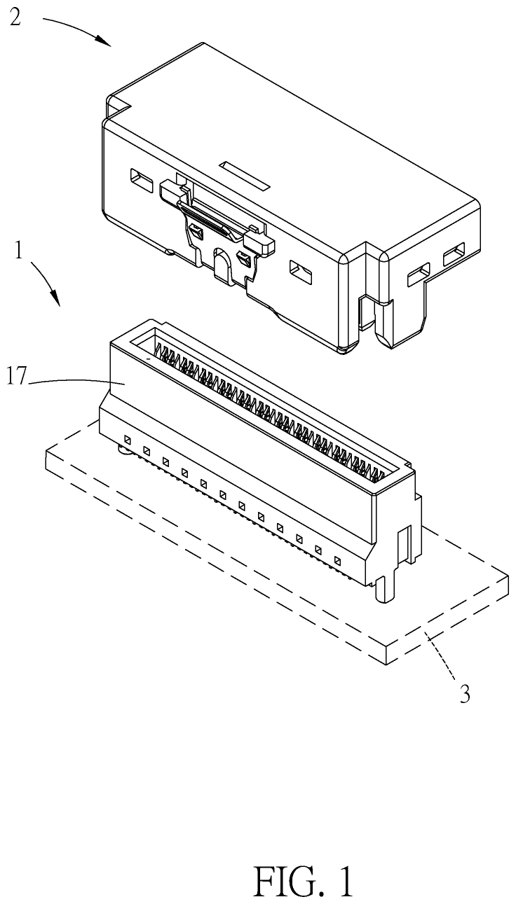

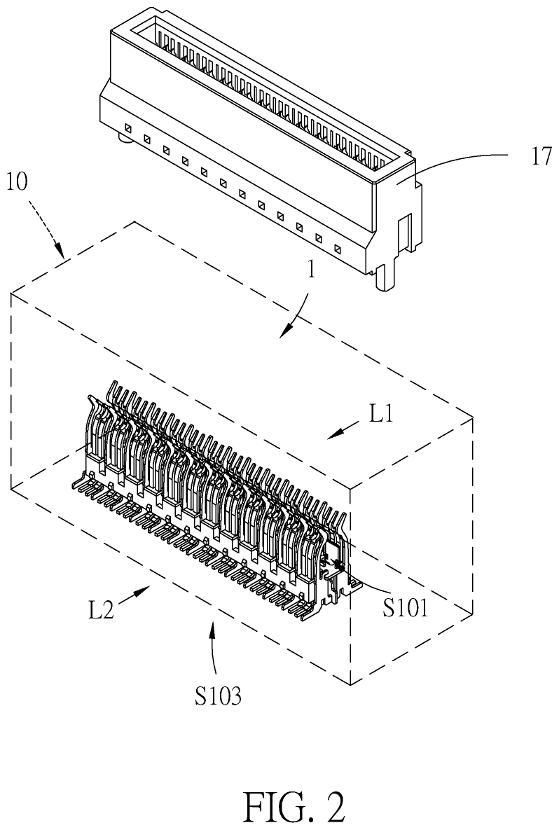

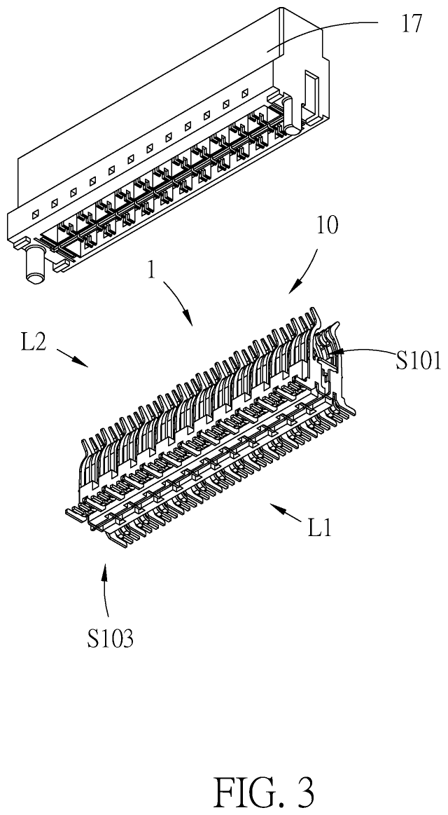

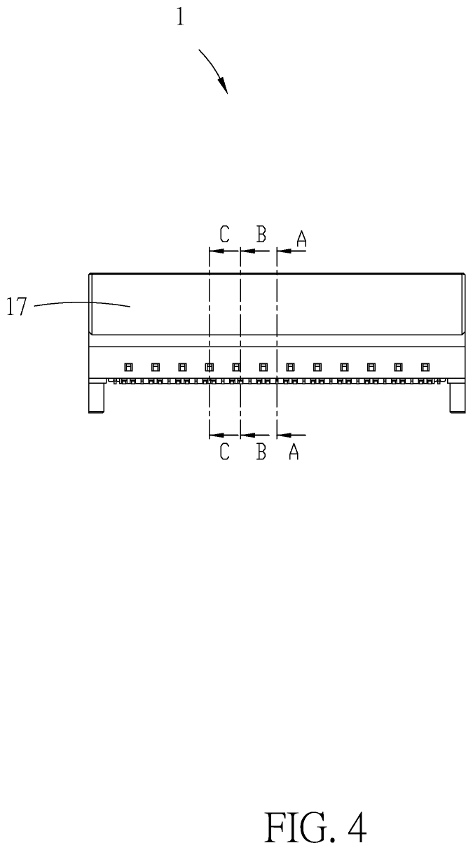

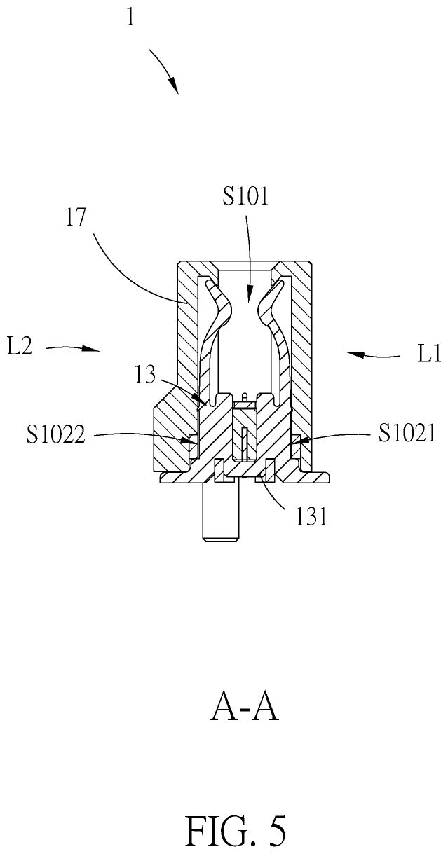

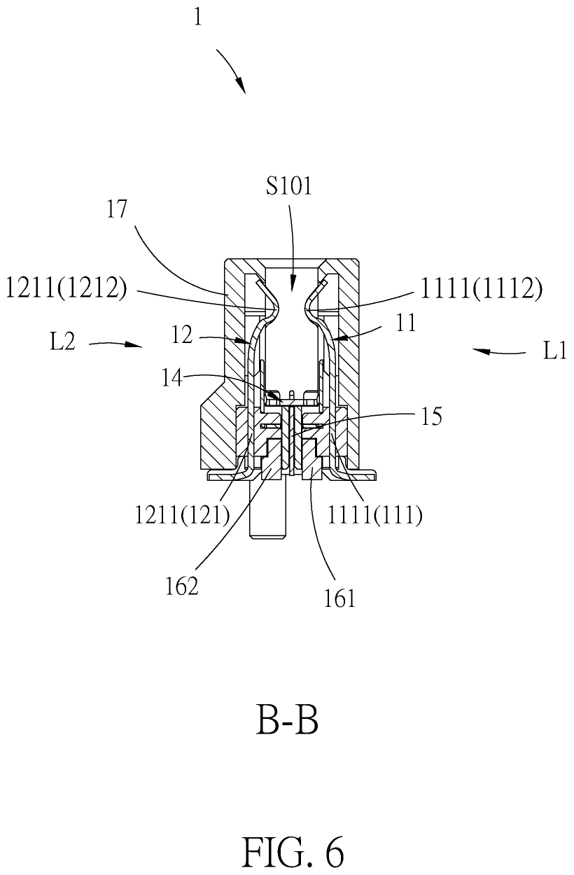

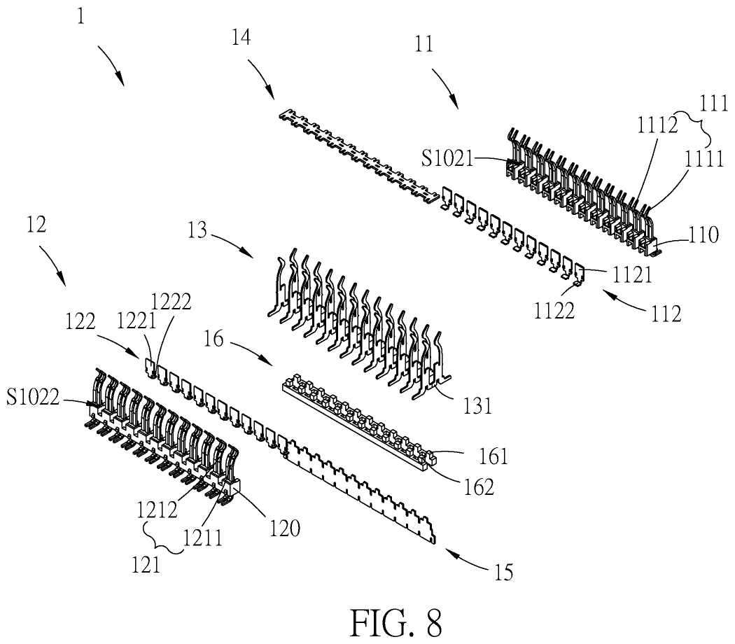

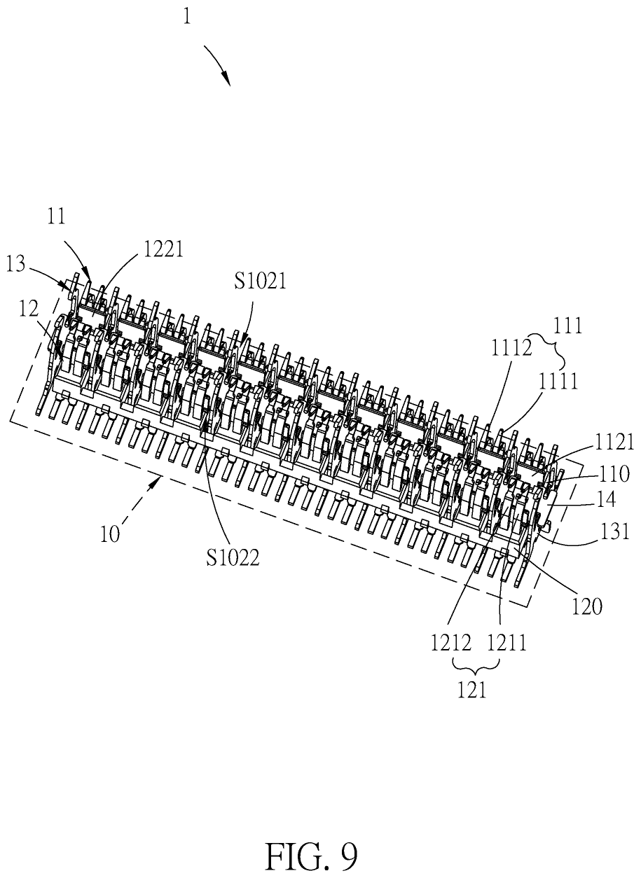

For a detailed description of the embodiments disclosed in the present application, please refer to FIGS. 1 to 9.

In the above-described embodiment, an electrical connector 1 is provided, the electrical connector 1 is configured to couple a coupling member 2 to provide signal transmission, and two sides of the electrical connector 1 may be defined as an electrical connector major side L1 and an electrical connector minor side L2, respectively. It should be noted that the coupling member 2 is, for example, a coupling connector configured to provide signal transmission.

In the embodiment shown in FIGS. 1 to 9, the electrical connector 1 comprises: an electrical connector body 10, a major side electrical connector submodule 11, a minor side electrical connector submodule 12, a grounded conductive terminal 13, a bridging conductive member 14, a mating conductive member 15, and an insulation housing 17.

Regarding the electrical connector body 10, the electrical connector body 10 comprises a coupling space S101, a major side non-grounded conductive terminal separating space S1021, and a minor side non-grounded conductive terminal separating space S1022.

Regarding the major side electrical connector submodule 11, the major side electrical connector submodule 11 is disposed at the electrical connector major side L1, and the major side electrical connector submodule 11 comprises a major side terminal insulation core 110, a major side non-grounded conductive terminal set 111, and a major side coupling space shielding conductive member 112. The major side non-grounded conductive terminal set 111 is configured to provide transmission of non-grounded signals such as differential signals, and the major side non-grounded conductive terminal set 111 comprises at least one first major side non-grounded conductive terminal 1111 and at least one second major side non-grounded conductive terminal 1112. The major side terminal insulation core 110 is made of an insulating material, and the major side terminal insulation core 110 is mated with the major side non-grounded conductive terminal set 111 and the major side coupling space shielding conductive member 112 to position the first major side non-grounded conductive terminal 1111, the second major side non-grounded conductive terminal 1112, and the major side coupling space shielding conductive member 112. Wherein, the major side non-grounded conductive terminal separating space S1021 is disposed between the first major side non-grounded conductive terminal 1111 and the second major side non-grounded conductive terminal 1112 to separate the first major side non-grounded conductive terminal 1111 from the second major side non-grounded conductive terminal 1112; and the first major side non-grounded conductive terminal 1111 and the second major side non-grounded conductive terminal 1112 extend into the coupling space S101 to provide coupling with the coupling member 2 for signal transmission.

Regarding the major side coupling space shielding conductive member 112, the major side coupling space shielding conductive member 112 is configured to transmit shielding signals such as grounding signals, and the major side coupling space shielding conductive member 112 extends into the coupling space S101 to provide electrical shielding for the first major side non-grounded conductive terminal 1111 and the second major side non-grounded conductive terminal 1112, thereby reducing interference with the signal transmission of the first major side non-grounded conductive terminal 1111 and the second major side non-grounded conductive terminal 1112. As such, the major side coupling space shielding conductive member 112 is configured to provide electrical shielding to reduce interference with the electrical connector 1 during high-speed signal transmission, thereby optimizing the transmission quality of the electrical connector 1 for high-speed signals to meet the specific requirements and development of electronic devices. It should be noted that the major side coupling space shielding conductive member 112 is, for example, a conductive metal member configured to transmit shielding signals.

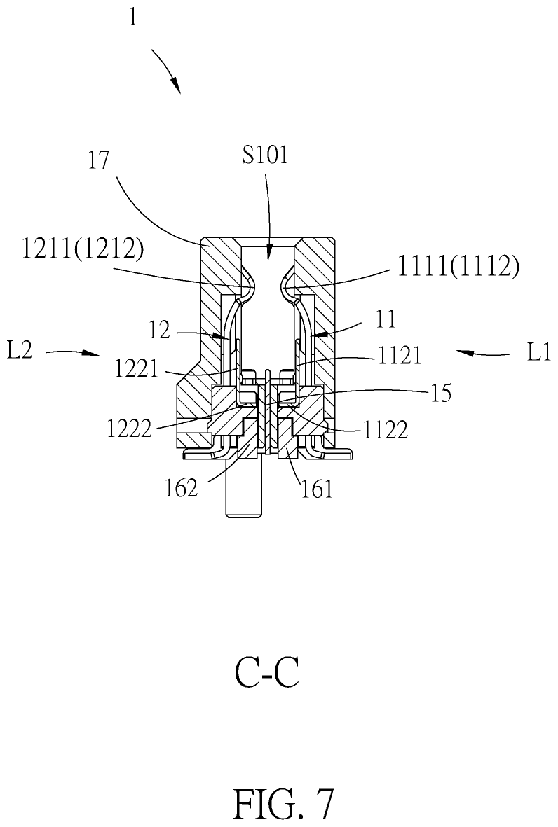

In the embodiment shown in FIG. 7, the major side coupling space shielding conductive member 112 comprises a major side coupling space shielding conductive member shielding wall 1121 and a major side coupling space shielding conductive member mating wall 1122, wherein the major side coupling space shielding conductive member shielding wall 1121 is disposed in the coupling space S101 to provide electrical shielding for the first major side non-grounded conductive terminal 1111 and the second major side non-grounded conductive terminal 1112; and the major side terminal insulation core 110 is mated with the major side coupling space shielding conductive member mating wall 1122 to position the major side coupling space shielding conductive member 112. It should be noted that the major side coupling space shielding conductive member shielding wall 1121 and the major side coupling space shielding conductive member mating wall 1122 may optionally be substantially perpendicular to each other.

Regarding the minor side electrical connector submodule 12, the minor side electrical connector submodule 12 is disposed at the electrical connector minor side L2, and the minor side electrical connector submodule 12 comprises a minor side terminal insulation core 120, a minor side non-grounded conductive terminal set 121, and a minor side coupling space shielding conductive member 122. The minor side non-grounded conductive terminal set 121 is configured to provide transmission of non-grounded signals such as differential signals, and the minor side non-grounded conductive terminal set 121 comprises at least one first minor side non-grounded conductive terminal 1211 and at least one second minor side non-grounded conductive terminal 1212. The minor side terminal insulation core 120 is made of an insulating material, and the minor side terminal insulation core 120 is mated with the minor side non-grounded conductive terminal set 121 and the minor side coupling space shielding conductive member 122 to position the first minor side non-grounded conductive terminal 1211, the second minor side non-grounded conductive terminal 1212, and the minor side coupling space shielding conductive member 122. Wherein, the minor side non-grounded conductive terminal separating space S1022 is disposed between the first minor side non-grounded conductive terminal 1211 and the second minor side non-grounded conductive terminal 1212 to separate the first minor side non-grounded conductive terminal 1211 from the second minor side non-grounded conductive terminal 1212; and the first minor side non-grounded conductive terminal 1211 and the second minor side non-grounded conductive terminal 1212 extend into the coupling space S101 to provide coupling with the coupling member 2 for signal transmission.

Regarding the minor side coupling space shielding conductive member 122, the minor side coupling space shielding conductive member 122 is configured to transmit shielding signals such as grounding signals, and the minor side coupling space shielding conductive member 122 extends into the coupling space S101 to provide electrical shielding for the first minor side non-grounded conductive terminal 1211 and the second minor side non-grounded conductive terminal 1212, thereby reducing interference with the signal transmission of the first minor side non-grounded conductive terminal 1211 and the second minor side non-grounded conductive terminal 1212. As such, the minor side coupling space shielding conductive member 122 is configured to provide electrical shielding to reduce interference with the electrical connector 1 during high-speed signal transmission, thereby optimizing the transmission quality of the electrical connector 1 for high-speed signals to meet the specific requirements and development of electronic devices. It should be noted that the minor side coupling space shielding conductive member 122 is, for example, a conductive metal member configured to transmit shielding signals.

In the embodiment shown in FIG. 7, the minor side coupling space shielding conductive member 122 comprises a minor side coupling space shielding conductive member shielding wall 1221 and a minor side coupling space shielding conductive member mating wall 1222, wherein the minor side coupling space shielding conductive member shielding wall 1221 is disposed in the coupling space S101 to provide electrical shielding for the first minor side non-grounded conductive terminal 1211 and the second minor side non-grounded conductive terminal 1212; and the minor side terminal insulation core 120 is mated with the minor side coupling space shielding conductive member mating wall 1222 to position the minor side coupling space shielding conductive member 122. It should be noted that the minor side coupling space shielding conductive member shielding wall 1221 and the minor side coupling space shielding conductive member mating wall 1222 may optionally be substantially perpendicular to each other orthogonal.

Regarding the grounded conductive terminal 13, the grounded conductive terminal 13 is configured to transmit shielding signals such as grounding signals, and the grounded conductive terminal 13 extending from the electrical connector major side L1 into the major side non-grounded conductive terminal separating space S1021 to provide electrical shielding between the first major side non-grounded conductive terminal 1111 and the second major side non-grounded conductive terminal 1112, thereby reducing interference with the signal transmission of the first major side non-grounded conductive terminal 1111 and the second major side non-grounded conductive terminal 1112. And the grounded conductive terminal 13 further extending from the electrical connector minor side L2 into the minor side non-grounded conductive terminal separating space S1022 to provide electrical shielding between the first minor side non-grounded conductive terminal 1211 and the second minor side non-grounded conductive terminal 1212, thereby reducing interference with the signal transmission of the first minor side non-grounded conductive terminal 1211 and the second minor side non-grounded conductive terminal 1212. As such, the grounded conductive terminal 13 is configured to provide electrical shielding to reduce interference with the electrical connector 1 during high-speed signal transmission, thereby optimizing the transmission quality of the electrical connector 1 for high-speed signals to meet the specific requirements and development of electronic devices. In addition, the grounded conductive terminal 13 further extends from the electrical connector major side L1 and the electrical connector minor side L2 into the coupling space S101 to provide coupling with the coupling member 2 for signal transmission.

Regarding the bridging conductive member 14, the bridging conductive member 14 extends into the coupling space S101 to respectively abut the major side coupling space shielding conductive member 112 and the minor side coupling space shielding conductive member 122 electrically, such that the major side coupling space shielding conductive member 112 and the minor side coupling space shielding conductive member 122 are electrically connected to transmit shielding signals. It should be noted that the bridging conductive member 14 is, for example, a conductive metal member configured to transmit shielding signals.

Regarding the mating conductive member 15, the mating conductive member 15 extends and is respectively mated with the grounded conductive terminal 13 and the bridging conductive member 14, so as to position the bridging conductive member 14 by the grounded conductive terminal 13, and to electrically connect the grounded conductive terminal 13 and the bridging conductive member 14 to transmit shielding signals. It should be noted that the mating conductive member 15 is, for example, a conductive metal member configured to transmit shielding signals.

It should be noted that the bridging conductive member 14 may optionally extend substantially laterally; and the mating conductive member 15 may optionally extend substantially longitudinally.

Regarding the insulation housing 17, the insulation housing 17 is mated with the major side terminal insulation core 110, the minor side terminal insulation core 120, and the grounded conductive terminal 13 to position the major side terminal insulation core 110, the minor side terminal insulation core 120, and the grounded conductive terminal 13.

In the embodiment shown in FIG. 1, the electrical connector 1 may further engage an engaging member 3 to provide signal transmission; correspondingly, the electrical connector body 10 further comprises an engaging space S103; the first major side non-grounded conductive terminal 1111 and the second major side non-grounded conductive terminal 1112 further extend into the engaging space S103 to provide engagement with the engaging member 3; the first minor side non-grounded conductive terminal 1211 and the second minor side non-grounded conductive terminal 1212 further extend into the engaging space S103 to provide engagement with the engaging member 3; the grounded conductive terminal 13 further extends from the electrical connector major side L1 and the electrical connector minor side L2 into the engaging space S103 to provide engagement with the engaging member 3 for signal transmission.

The electrical connector 1 further comprises an engaging space shielding conductive member 16, the engaging space shielding conductive member 16 extends into the engaging space S103 to provide electrical shielding between the major side non-grounded conductive terminal set 111 and the minor side non-grounded conductive terminal set 121, thereby reducing interference with the signal transmission of the major side non-grounded conductive terminal set 111 and the minor side non-grounded conductive terminal set 121. As such, the engaging space shielding conductive member 16 is configured to provide electrical shielding to reduce interference with the electrical connector 1 during high-speed signal transmission, thereby optimizing the transmission quality of the electrical connector 1 for high-speed signals to meet the specific requirements and development of electronic devices.

Correspondingly, the grounded conductive terminal 13 further comprises an engaging space shielding conductive member mating structure 131, the engaging space shielding conductive member mating structure 131 is mated with the engaging space shielding conductive member 16 to position the engaging space shielding conductive member 16, and to electrically connect the grounded conductive terminal 13 and the engaging space shielding conductive member 16 to transmit shielding signals. It should be noted that the engaging space shielding conductive member 16 is, for example, a conductive plastic member configured to transmit shielding signals.

It should be noted that in the embodiments of the present application, some of the aforementioned members may also be omitted. For example, the electrical connector of the present application may optionally comprise: an electrical connector body, a major side electrical connector submodule, a minor side electrical connector submodule, a grounded conductive terminal, a bridging conductive member, and a mating conductive member. The electrical connector body comprises a coupling space, a major side non-grounded conductive terminal separating space, and a minor side non-grounded conductive terminal separating space. The major side electrical connector submodule is disposed at the electrical connector major side, and the major side electrical connector submodule comprises a major side non-grounded conductive terminal set and a major side coupling space shielding conductive member, the major side non-grounded conductive terminal set comprises a first major side non-grounded conductive terminal and a second major side non-grounded conductive terminal, wherein the major side non-grounded conductive terminal separating space is disposed between the first major side non-grounded conductive terminal and the second major side non-grounded conductive terminal to separate the first major side non-grounded conductive terminal from the second major side non-grounded conductive terminal; the first major side non-grounded conductive terminal and the second major side non-grounded conductive terminal extend into the coupling space to provide coupling; and the major side coupling space shielding conductive member extends into the coupling space to provide electrical shielding for the first major side non-grounded conductive terminal and the second major side non-grounded conductive terminal. The minor side electrical connector submodule is disposed at the electrical connector minor side, and the minor side electrical connector submodule comprises a minor side non-grounded conductive terminal set and a minor side coupling space shielding conductive member, the minor side non-grounded conductive terminal set comprises a first minor side non-grounded conductive terminal and a second minor side non-grounded conductive terminal, wherein the minor side non-grounded conductive terminal separating space is disposed between the first minor side non-grounded conductive terminal and the second minor side non-grounded conductive terminal to separate the first minor side non-grounded conductive terminal from the second minor side non-grounded conductive terminal; the first minor side non-grounded conductive terminal and the second minor side non-grounded conductive terminal extend into the coupling space to provide coupling; and the minor side coupling space shielding conductive member extends into the coupling space to provide electrical shielding for the first minor side non-grounded conductive terminal and the second minor side non-grounded conductive terminal. The grounded conductive terminal extends from the electrical connector major side into the major side non-grounded conductive terminal separating space to provide electrical shielding between the first major side non-grounded conductive terminal and the second major side non-grounded conductive terminal, and the grounded conductive terminal further extends from the electrical connector minor side into the minor side non-grounded conductive terminal separating space to provide electrical shielding between the first minor side non-grounded conductive terminal and the second minor side non-grounded conductive terminal; the grounded conductive terminal further extends from the electrical connector major side and the electrical connector minor side into the coupling space to provide coupling. The bridging conductive member extends into the coupling space to respectively abut the major side coupling space shielding conductive member and the minor side coupling space shielding conductive member electrically, such that the major side coupling space shielding conductive member and the minor side coupling space shielding conductive member are electrically connected. The mating conductive member extends and is respectively mated with the grounded conductive terminal and the bridging conductive member, so as to position the bridging conductive member by the grounded conductive terminal, and to electrically connect the grounded conductive terminal and the bridging conductive member.

In summary, the electrical connector of the present application may be disposed in an electronic device to transmit signals, and the electrical connector comprises a plurality of non-grounded conductive terminal sets, a shielding conductive member, and a grounded conductive terminal, wherein the shielding conductive member is disposed between the plurality of non-grounded conductive terminal sets, the grounded conductive terminal is configured to be electrically connected to the shielding conductive member to transmit shielding signals such as grounding signals, thereby providing electrical shielding for the signal transmission of the plurality of non-grounded conductive terminal sets; as such, interference with the electrical connector during high-speed signal transmission may be effectively reduced, thereby optimizing the transmission quality of the electrical connector for high-speed signals to meet the specific requirements and development of electronic devices. The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, two sides of the electrical connector are an electrical connector major side and an electrical connector minor side, the electrical connector comprising:
an electrical connector body comprising a coupling space, a major side non-grounded conductive terminal separating space, and a minor side non-grounded conductive terminal separating space;
a major side electrical connector submodule disposed at the electrical connector major side, the major side electrical connector submodule comprising a major side non-grounded conductive terminal set and a major side coupling space shielding conductive member, the major side non-grounded conductive terminal set comprising a first major side non-grounded conductive terminal and a second major side non-grounded conductive terminal, wherein the major side non-grounded conductive terminal separating space is disposed between the first major side non-grounded conductive terminal and the second major side non-grounded conductive terminal to separate the first major side non-grounded conductive terminal from the second major side non-grounded conductive terminal; the first major side non-grounded conductive terminal and the second major side non-grounded conductive terminal extend into the coupling space to provide coupling; and the major side coupling space shielding conductive member extends into the coupling space to provide electrical shielding for the first major side non-grounded conductive terminal and the second major side non-grounded conductive terminal;
a minor side electrical connector submodule disposed at the electrical connector minor side, the minor side electrical connector submodule comprising a minor side non-grounded conductive terminal set and a minor side coupling space shielding conductive member, the minor side non-grounded conductive terminal set comprising a first minor side non-grounded conductive terminal and a second minor side non-grounded conductive terminal, wherein the minor side non-grounded conductive terminal separating space is disposed between the first minor side non-grounded conductive terminal and the second minor side non-grounded conductive terminal to separate the first minor side non-grounded conductive terminal from the second minor side non-grounded conductive terminal; the first minor side non-grounded conductive terminal and the second minor side non-grounded conductive terminal extend into the coupling space to provide coupling; and the minor side coupling space shielding conductive member extends into the coupling space to provide electrical shielding for the first minor side non-grounded conductive terminal and the second minor side non-grounded conductive terminal;
a grounded conductive terminal extending from the electrical connector major side into the major side non-grounded conductive terminal separating space to provide electrical shielding between the first major side non-grounded conductive terminal and the second major side non-grounded conductive terminal; the grounded conductive terminal further extending from the electrical connector minor side into the minor side non-grounded conductive terminal separating space to provide electrical shielding between the first minor side non-grounded conductive terminal and the second minor side non-grounded conductive terminal; and the grounded conductive terminal further extending from the electrical connector major side and the electrical connector minor side into the coupling space to provide coupling;
a bridging conductive member extending into the coupling space to electrically abut the major side coupling space shielding conductive member and the minor side coupling space shielding conductive member respectively, such that the major side coupling space shielding conductive member and the minor side coupling space shielding conductive member are electrically connected to each other; and
a mating conductive member extending to and respectively mated with the grounded conductive terminal and the bridging conductive member, so as to position the bridging conductive member by the grounded conductive terminal and to electrically connect the grounded conductive terminal and the bridging conductive member.

2. The electrical connector of claim 1, wherein the major side coupling space shielding conductive member, the minor side coupling space shielding conductive member, the bridging conductive member, and the mating conductive member are conductive metal members.

3. The electrical connector of claim 1, wherein the bridging conductive member extends substantially laterally, and the mating conductive member extends substantially longitudinally.

4. The electrical connector of claim 1, wherein the major side electrical connector submodule further comprises a major side terminal insulation core mated with the major side non-grounded conductive terminal set and the major side coupling space shielding conductive member to position the first major side non-grounded conductive terminal, a second major side non-grounded conductive terminal, and the major side coupling space shielding conductive member; and the minor side electrical connector submodule further comprises a minor side terminal insulation core mated with the minor side non-grounded conductive terminal set and the minor side coupling space shielding conductive member to position the first minor side non-grounded conductive terminal, a second minor side non-grounded conductive terminal, and the minor side coupling space shielding conductive member.

5. The electrical connector of claim 4, wherein the major side coupling space shielding conductive member comprises a major side coupling space shielding conductive member shielding wall and a major side coupling space shielding conductive member mating wall, wherein the major side coupling space shielding conductive member shielding wall is disposed in the coupling space to provide electrical shielding for the first major side non-grounded conductive terminal and the second major side non-grounded conductive terminal; and the major side terminal insulation core is mated with the major side coupling space shielding conductive member mating wall to position the major side coupling space shielding conductive member; and the minor side coupling space shielding conductive member comprises a minor side coupling space shielding conductive member shielding wall and a minor side coupling space shielding conductive member mating wall, wherein the minor side coupling space shielding conductive member shielding wall is disposed in the coupling space to provide electrical shielding for the first minor side non-grounded conductive terminal and the second minor side non-grounded conductive terminal; and the minor side terminal insulation core is mated with the minor side coupling space shielding conductive member mating wall to position the minor side coupling space shielding conductive member.

6. The electrical connector of claim 5, wherein the major side coupling space shielding conductive member shielding wall and the major side coupling space shielding conductive member mating wall are substantially perpendicular to each other; and the minor side coupling space shielding conductive member shielding wall and the minor side coupling space shielding conductive member mating wall are substantially perpendicular to each other.

7. The electrical connector of claim 4, wherein the electrical connector body further comprises an engaging space; the first major side non-grounded conductive terminal and the second major side non-grounded conductive terminal further extend into the engaging space to provide engagement; the first minor side non-grounded conductive terminal and the second minor side non-grounded conductive terminal further extend into the engaging space to provide engagement; the grounded conductive terminal further extends from the electrical connector major side and the electrical connector minor side respectively into the engaging space to provide engagement; and the electrical connector further comprises an engaging space shielding conductive member extending into the engaging space to provide electrical shielding between the major side non-grounded conductive terminal set and the minor side non-grounded conductive terminal set; the grounded conductive terminal further comprises an engaging space shielding conductive member mating structure mated with the engaging space shielding conductive member to position the engaging space shielding conductive member and to electrically connect the grounded conductive terminal and the engaging space shielding conductive member.

8. The electrical connector of claim 7, wherein the engaging space shielding conductive member comprises a major side engaging space shielding conductive sub-member and a minor side engaging space shielding conductive sub-member; wherein the major side engaging space shielding conductive sub-member is disposed at the electrical connector major side, and the minor side engaging space shielding conductive sub-member is disposed at the electrical connector minor side.

9. The electrical connector of claim 7, wherein the engaging space shielding conductive member is a conductive plastic member.

10. The electrical connector of claim 7, further comprising: an insulation housings mated with the major side terminal insulation core, the minor side terminal insulation core, and the grounded conductive terminal to position the major side terminal insulation core, the minor side terminal insulation core, and the grounded conductive terminal.
